(19) United States
(12) Patent Application Publication
(10) Pub. No.: US 2025/0061384 A1
(43) Pub. Date: Feb. 20, 2025

(54) SYSTEMS AND METHODS FOR ENCODING AND CLASSIFYING DATA

(71) Applicant: NOBLIS, INC., Reston, VA (US)

(72) Inventors: Brian BACARAT-DONAVAN, Leesburg, VA (US); Riley WHITE, Harrisonburg, VA (US); John HELMSEN, Rockville, MD (US)

(73) Assignee: NOBLIS, INC., Reston, VA (US)

(21) Appl. No.: 18/805,676

(22) Filed: Aug. 15, 2024

Related U.S. Application Data
(60) Provisional application No. 63/533,033, filed on Aug. 16, 2023.

(51) Int. Cl. G06N 20/10

(52) U.S. Cl. CPC G06N 20/10

(57) ABSTRACT

Systems, devices, and methods for training a machine learning model and classifying encoded data include an exemplary method that includes: receiving first training data, by a variational autoencoder (VAE) comprising a probabilistic encoder and a probabilistic decoder; and encoding the first training data, by the probabilistic encoder, to generate encoded data in an embedding space; decoding the encoded data, by the probabilistic decoder, to generate decoded data; computing a loss function, comprising a hinge-loss term, based on the decoded data and the encoded data; and adjusting one or more parameters of the VAE based on the computed loss function including the hinge-loss term. The exemplary method may include classifying, by a linear support vector machine (SVM), the encoded data in the embedding space wherein classifying comprises determining the hyperplane in the embedding space separating the first class of the encoded data from the second class of the encoded data.

### CROSS-REFERENCE TO RELATED APPLICATIONS

This application claims the priority of U.S. Provisional Application No. 63/533,033, filed Aug. 16, 2023, the entire contents of which are incorporated herein by reference.

### FIELD

This application relates generally to systems and methods for encoding and classifying data, and more specifically to using machine learning models for encoding data, classifying encoded data, and decoding encoded data.

### BACKGROUND

Variational autoencoders (VAEs) are neural network systems that include a probabilistic encoder, a probabilistic decoder, and a loss function. The probabilistic encoder is configured to encode input data into a lower dimensional embedding space (also referred to as a latent space) and the probabilistic decoder is configured to decode the encoded data in the latent space to generate output data that attempts to faithfully reconstruct the input data.

The loss function of a traditional VAE includes two terms: a generative (or reconstruction) loss term and a latent (or regularization) loss term. The generative loss term imposes a penalty on the variational autoencoder when the error between the input data and the encoded-decoded data is too high. In other words, the generative loss term is configured to increase the efficiency and accuracy of the encoding-decoding scheme. The latent loss term is configured to enforce normal distributions of encoded data within the embedding (or latent) space. As such, the latent loss term encourages the VAE to encode data such that points that are near each other in the latent space are similar to each other once decoded.

Separately, support vector machines (SVMs) are machine learning models that can be used for data analysis including classification and regression analysis. SVMs can perform linear classification (e.g., assigning unlabeled data to a category selected from a set of categories) by dividing classes by a separating hyperplane. SVMs can also perform non-linear classification by using a kernel trick to map inputs into high dimensional feature spaces.

### SUMMARY

Described herein are systems, devices, and methods for training and implementing machine learning models for encoding and decoding data and classifying encoded data in accordance with some embodiments. In some embodiments, an exemplary system includes a variational autoencoder (VAE) integrated with a support vector machine (SVM), and the system is configured to enable a non-technical user to train and use the VAE and/or SVM to classify data.

In some embodiments, system is configured for performing anomaly detection and classification across a wide variety of data types. The systems and methods disclosed herein can further improve classification by a support vector machine (SVM) classifier using a novel configuration of a variational autoencoder (VAE). The VAEs disclosed herein include the aforementioned two loss function terms, the generative loss term and the latent loss term, but also include a third loss term, a hinge-loss term. The probabilistic encoder of the VAE can be trained by minimizing the loss function, including the hinge loss, which causes the VAE to separate the first input data into a first class and a second class in the embedding space, the first and second class being separated by a hyperplane.

Training the VAE by minimizing a hinge loss to encode the data such that it is separated in this manner within the embedding space allows a linear SVM to efficiently determine hyperplanes defining linear boundaries between different classes of encoded data. As such, a linear SVM can be configured to receive encoded data from an embedding space, where the embedding space includes encoded data encoded by a probabilistic encoder of the VAE. Prior to receipt by the SVM, the encoded data received by the SVM will have been distributed within the embedding space by the VAE (trained by minimizing a hinge loss function as described above) in a manner that makes the encoded data amenable to efficient and accurate classification into classes by the SVM. That is to say, the encoded data in the embedding space may be arranged in a plurality of clusters within the embedding space, making it straightforward and effective for the SVM to classify embedded data points in one cluster into a first class and embedded data points in another cluster into a second class. Thus, the SVM can readily classify the embedded data points within each delineated cluster of data points.

In some embodiments, the system is configured to explain its various functionality (i.e., provide counterfactuals), including for anomaly detection and classification. In some embodiments, the explanations include counterfactuals. For instance, the system may be configured to explain to a user what changes to the input data would result in different classifications. In some embodiments, the system may identify datum falling near a classification boundary and prompt a user to label the datum. In some embodiments, the systems disclosed herein can identify a minimum sufficient adjustment to higher dimensional data (e.g., changing of a limited number of variables for a given datum) that would cause an encoded datum generated based on the adjusted datum to be classified in a different class by the SVM. Therefore, the system can enable non-technical users to train the machine learning models described herein.

The system may further be configured generate synthetic training data and request user inputs comprising labels for one or more datum in the synthetic training data. Thus, the system can be configured to allow for more efficient training of various machine learning classification operations by simplifying the data labeling process for training of machine learning models. The systems and methods disclosed herein can further be configured for configuration/model drift detection, in which the systems and methods disclosed herein can further be configured to identify when one or more aspects of the VAE or SVM are out of date, and to retrain the VAE or SVM accordingly.

Thus, in some embodiments, the systems and methods described herein combine explainability (e.g., of anomaly detection and classification, among other functionality), anomaly detection, classification (including semi-supervised multi-class classification), active learning, model-drift detection (detecting when the model is stale against the data it is classifying and needs to be retrained), schema-based architecture (i.e., training can begin where only the data schema is known), and synthetic data generation (allowing users to determine what the system believes it has learned for debugging and analysis, and which can also be used to create representative data sets of the original data, for instance with the Personally Identifiable Information scrubbed out).

An exemplary method for training a machine learning model comprises: receiving first training data, by a variational autoencoder (VAE) comprising a probabilistic encoder and a probabilistic decoder; and encoding the first training data, by the probabilistic encoder, to generate encoded data in an embedding space; decoding the encoded data, by the probabilistic decoder, to generate decoded data; computing a loss function, comprising a hinge-loss term, based on the decoded data and the encoded data; and adjusting one or more parameters of the VAE based on the computed loss function including the hinge-loss term.

In some examples, adjusting the one or more parameters of the VAE based on the hinge-loss term configures the VAE to separate data in the embedding space by a hyperplane.

In some examples, adjusting the one or more parameters of the VAE based on the hinge-loss term configures the VAE to maximize a margin between a first class of encoded data on a first side of the hyperplane and a second class of encoded data on a second side of the hyperplane.

In some examples, the loss function further comprises a generative-loss term and a latent-loss term.

In some examples, adjusting the one or more parameters of the VAE based on the computed loss function comprises adjusting the one or more parameters of the VAE based on the generative-loss term to minimize the difference between the training data and the decoded output data.

In some examples, the generative-loss term comprises an L2-loss term, wherein the L2-loss term comprises a squared difference between a decoded output data and the training data.

In some examples, adjusting the one or more parameters of the VAE based on the computed loss function comprises adjusting the one or more parameters of the VAE based on the latent-loss term to regularize a covariance matrix and a mean of a distribution, wherein the covariance matrix and the mean of the distribution are returned by the probabilistic encoder.

In some examples, the regularization of the covariance matrix and the mean of the distribution comprises regularization to a Gaussian distribution.

In some examples, the latent-loss term comprises a Kullback-Leibler divergence loss term.

In some examples, the method further comprises identifying an uncertain datum in the embedding space, wherein the uncertain datum comprises an unlabeled datum nearest to a hyperplane separating the first class of data and second class of data; and requesting user input, wherein the user input comprises a label for the uncertain datum.

In some examples, the method further comprises retraining the VAE based on the user input comprising the label for the uncertain datum, wherein retraining the VAE results in the first and second class of data being separated by a second hyperplane in embedding space different from the first hyperplane.

In some examples, the method further comprises generating, by the variational autoencoder, synthetic training data; and prompting, by one or more processors, a user to label one or more datum in the generated synthetic data.

In some examples, the method further comprises retraining the VAE based on the labeled synthetic training data and the first input data.

In some examples, retraining the VAE results in the first and second class of data being separated by a second hyperplane in embedding space different from the first hyperplane.

In some examples, the method further comprises: configuring a linear support vector machine (SVM) to classify encoded data in the embedding space into a first class of encoded data in the embedding space and a second class of encoded data in the embedding space, wherein the first class of encoded data and the second class of encoded data are separated in the embedding space by a hyperplane, and wherein the VAE is configured based on minimizing the hinge-loss term to maximize a margin between the first class of the encoded data and the second class of the encoded data for classification by the SVM.

In some embodiments, the linear SVM is configured to determine the hyperplane separating the first class of data from the second class of data.

In some embodiment, the method further comprises: generating, by one or more processors, an output, wherein the output comprises an explanation of a minimum sufficient adjustment to one or more variables associated in the input data with a first encoded datum classified by the SVM in the first class that would cause the VAE to re-encode and the SVM to re-classify the re-encoded datum in the second class.

An exemplary system for training a machine learning model comprises one or more processors configured to cause the system to: receive first training data, by a variational autoencoder (VAE) comprising a probabilistic encoder and a probabilistic decoder; and encode the first training data, by the probabilistic encoder, to generate encoded data in an embedding space; decode the encoded data, by the probabilistic decoder, to generate decoded data; compute a loss function, comprising a hinge-loss term, based on the decoded data and the encoded data; and adjust one or more parameters of the VAE based on the computed loss function including the hinge-loss term.

An exemplary non-transitory computer-readable storage medium for training a machine learning model stores instructions configured to be executed by one or more processors of a system to cause the system to: receive first training data, by a variational autoencoder (VAE) comprising a probabilistic encoder and a probabilistic decoder; and encode the first training data, by the probabilistic encoder, to generate encoded data in an embedding space; decode the encoded data, by the probabilistic decoder, to generate decoded data; compute a loss function, comprising a hinge-loss term, based on the decoded data and the encoded data; and adjust one or more parameters of the VAE based on the computed loss function including the hinge-loss term.

An exemplary system for classifying encoded data comprises one or more processors configured to cause the system to: receive, by a probabilistic encoder of a variational autoencoder (VAE), first input data; generate, by the probabilistic encoder based on the input data, encoded data in an embedding space, wherein the encoded data in the embedding space comprises a first class of encoded data separated by a hyperplane from a second class of encoded data; and classify, by a linear support vector machine (SVM), the encoded data in the embedding space wherein classifying the encoded data comprises determining the hyperplane in the embedding space separating the first class of the encoded data from the second class of the encoded data.

In some examples of the system for classifying encoded data, the one or more processors are configured to: for a first encoded datum classified in the first class of the encoded data, identify a minimum sufficient adjustment to one or more variables associated in the first input data with the first encoded datum, the minimum sufficient adjustment configured to cause the VAE to re-encode the first encoded datum and the SVM to re-classify the re-encoded datum in the second class.

In some examples of the system for classifying encoded data, identifying the minimum sufficient adjustment to the first datum comprises: ranking each variable associated with the encoded datum based on an amount that each respective variable causes the datum to move toward the hyperplane separating the first and second classes of data; and changing the variable with the highest ranking.

In some examples of the system for classifying encoded data, the VAE is trained by: encoding training data, by a probabilistic encoder, to generate encoded data in an embedding space; decoding the encoded data, by the probabilistic decoder, to generate decoded data; computing a loss function, comprising a hinge-loss term, based on the decoded data and the encoded data; and adjusting one or more parameters of the VAE based on the computed loss function including the hinge-loss term.

In some examples of the system for classifying encoded data, adjusting the one or more parameters of the VAE based on the hinge-loss term configures the VAE to separate data in the embedding space by a hyperplane.

In some examples of the system for classifying encoded data, adjusting the one or more parameters of the VAE based on the hinge-loss term configures the VAE to maximize a margin between a first class of encoded data on a first side of the hyperplane and a second class of encoded data on a second side of the hyperplane.

In some examples of the system for classifying encoded data, the loss function further comprises a generative-loss term and a latent-loss term.

In some examples of the system for classifying encoded data, adjusting the one or more parameters of the VAE based on the computed loss function comprises adjusting the one or more parameters of the VAE based on the generative-loss term to minimize the difference between the training data and the decoded output data.

In some examples of the system for classifying encoded data, the generative-loss term comprises an L2-loss term, wherein the L2-loss term comprises a squared difference between a decoded output data and the training data.

In some examples of the system for classifying encoded data, adjusting the one or more parameters of the VAE based on the computed loss function comprises adjusting the one or more parameters of the VAE based on the latent-loss term to regularize a covariance matrix and a mean of a distribution, wherein the covariance matrix and the mean of the distribution are returned by the probabilistic encoder.

In some examples of the system for classifying encoded data, the regularization of the covariance matrix and the mean of the distribution comprises regularization to a Gaussian distribution.

In some examples of the system for classifying encoded data, the VAE is further trained by: identifying an uncertain datum in the embedding space, the uncertain datum comprising an unlabeled datum nearest to the hyperplane separating the first class of data and second class of data; requesting user input, the user input comprising a label for the uncertain datum; and retraining the VAE based on the label for the uncertain datum, retraining the VAE resulting in the first and second class of data being separated by a second hyperplane in embedding space different from the first hyperplane.

In some examples of the system for classifying encoded data, the one or more processors are further configured to: generate, by the variational autoencoder, synthetic training data; and prompt a user to label one or more datum in the generated synthetic data.

In some examples of the system for classifying encoded data, the one or more processors are further configured to: retrain the VAE based on the labeled synthetic training data and the first input data.

In some examples of the system for classifying encoded data, retraining the VAE results in the first and second class of data being separated by a second hyperplane in embedding space different from the first hyperplane.

In some examples of the system for classifying encoded data, the one or more processors are further configured to cause the system to: generate an output, wherein the output comprises an explanation of a minimum sufficient adjustment to one or more variables associated in the first input data with a first encoded datum to cause the VAE to re-encode the first encoded datum and the SVM to re-classify the re-encoded datum in the second class.

An exemplary method for classifying encoded data comprises: receiving, by a probabilistic encoder of a variational autoencoder (VAE), first input data; generating, by the probabilistic encoder based on the input data, encoded data in an embedding space, wherein the encoded data in the embedding space comprises a first class of encoded data separated by a hyperplane from a second class of encoded data; and classifying, by a linear support vector machine (SVM), the encoded data in the embedding space wherein classifying comprises determining the hyperplane in the embedding space separating the first class of the encoded data from the second class of the encoded data.

An exemplary non-transitory computer-readable storage medium for training a machine learning model stores instructions configured to be executed by one or more processors of a system to cause the system to: receive, by a probabilistic encoder of a variational autoencoder (VAE), first input data; generate, by the probabilistic encoder based on the input data, encoded data in an embedding space, wherein the encoded data in the embedding space comprises a first class of encoded data separated by a hyperplane from a second class of encoded data; and classify, by a linear support vector machine (SVM), the encoded data in the embedding space wherein classifying comprises determining the hyperplane in the embedding space separating the first class of the encoded data from the second class of the encoded data.

### BRIEF DESCRIPTION OF THE FIGURES

The patent or application file contains at least one drawing executed in color. Copies of this patent or patent application publication with color drawings will be provided by the office upon request and payment of the necessary fee.

FIG. 1 illustrates an exemplary system architecture according to one or more examples.

FIG. 2 illustrates an exemplary method for training a variational autoencoder according to one or more examples.

FIG. 3 illustrates an exemplary method for generating and labeling synthetic training data using a variational autoencoder according to one or more examples.

FIG. 4 illustrates an exemplary method for classifying encoded data using a linear support vector machine according to one or more examples.

FIG. 5 illustrates an exemplary hyperplane segmented embedding space according to one or more examples.

FIG. 6 illustrates an exemplary hyperplane separating data classes in an embedding space shifting in response to a user input according to one or more examples.

FIG. 7 illustrates an exemplary computing system according to one or more examples.

FIG. 8 illustrates an adversarial attack changing the reconstruction of an encoded image.

### DETAILED DESCRIPTION

Described herein are systems, devices, and methods for training and implementing models for encoding and decoding data and classifying encoded data in accordance with some embodiments. In some embodiments, an exemplary system disclosed herein integrates a variational autoencoder (VAE) with a linear support vector machine (SVM) to efficiently and accurately classify input data. In some embodiments, the systems and methods disclosed herein can improve classification by a support vector machine (SVM) classifier using a novel configuration of a variational autoencoder (VAE). The VAEs disclosed herein include the aforementioned two loss function terms, the generative loss term and the latent loss term, but also include a third loss term, a hinge-loss term. The probabilistic encoder of the VAE can be trained by minimizing the hinge loss, which causes the VAE to separate the first input data into a first class and a second class in the embedding space, the first and second class being separated by a hyperplane.

Training the VAE by minimizing a hinge loss to encode the data such that it is separated in this manner within the embedding space allows a linear SVM to efficiently determine hyperplanes defining linear boundaries between different classes of encoded data. As such, a linear SVM can be configured to receive encoded data from an embedding space, where the embedding space includes encoded data encoded by a probabilistic encoder of the VAE. Prior to receipt by the SVM, the encoded data received by the SVM will have been distributed within the embedding space by the VAE (trained by minimizing a hinge loss function as described above) in a manner that makes the encoded data amenable to efficient and accurate classification into classes by the SVM. That is to say, the encoded data in the embedding space may be arranged in a plurality of clusters within the embedding space, making it straightforward and effective for the SVM to classify embedded data points in one cluster into a first class and embedded data points in another cluster into a second class. Thus, the SVM can readily classify the data points within each delineated cluster of data points using a hyperplane that forms a linear boundary separating the clusters of data points.

In some embodiments, all functionality, including anomaly detection and classification, is explainable by the system. For instance, the systems disclosed herein can identify a minimum sufficient adjustment to higher dimensional data (e.g., changing of a limited number of variables for a given datum) that would cause an encoded datum generated based on the adjusted datum to be classified in a different class by the SVM. The explainability of anomaly detection and classification across a wide variety of data types may enable non-technical users to train the machine learning models described herein. The system can explain to users what changes to the input data would result in different classifications, thus allowing non-technical users to interact with the data and/or retrain the VAE/SVM based on newly labeled training data.

In some embodiments, the systems and methods disclosed herein are configured for active learning and generative active learning to streamline training of various machine learning models. Passive learning involves a user selecting data from unlabeled data, providing labels, and retraining a model with the new labels. Active learning involves the machine (i.e., the model) selecting data from unlabeled data, receiving user unput label(s), and retraining the model with the new label(s). Generative active learning includes the machine selecting data from unlabeled data and/or generating or creating new (synthetic) data to retrain the model. For instance, the systems disclosed herein can be configured to request user inputs, the inputs comprising labels for uncertain datum in a dataset. The system may further be configured generate synthetic training data and request user inputs comprising labels for one or more datum in the synthetic training data. Thus, the system can be configured to allow for more efficient training of various machine learning classification operations by simplifying the data labeling process for training of machine learning models.

Accordingly, the system can assist users in cleaning and labeling data sets (anomaly detection, semi-supervised learning) instead of requiring cleaned and labeled data sets from the outset. This allows users to be immediately productive in understanding, analyzing and exploiting the data as soon as the system starts running, irrespective of the initial condition of the data. Additionally, the types of embeddings generated by VAEs provide additional functionality for the user, such as synthetic data generation, active learning, and detection of model drift. With respect to model drift detection, the systems disclosed herein can further be configured to identify when one or more aspects of the VAE or SVM are out of date, and to retrain the VAE or SVM accordingly.

Therefore, the system combines explainability (e.g., of anomaly detection and classification, among other functionality), anomaly detection, semi-supervised multi-class classification, active learning, model-drift detection (detecting when the model is stale against the data it is classifying and needs to be retrained), schema-based architecture (i.e., training can begin where only the data schema is known), and synthetic data generation (allowing users to determine what the system believes it has learned for debugging and analysis, and which can also be used to create representative data sets of the original data, for instance with the Personally Identifiable Information scrubbed out). Details of the above referenced features are provided below.

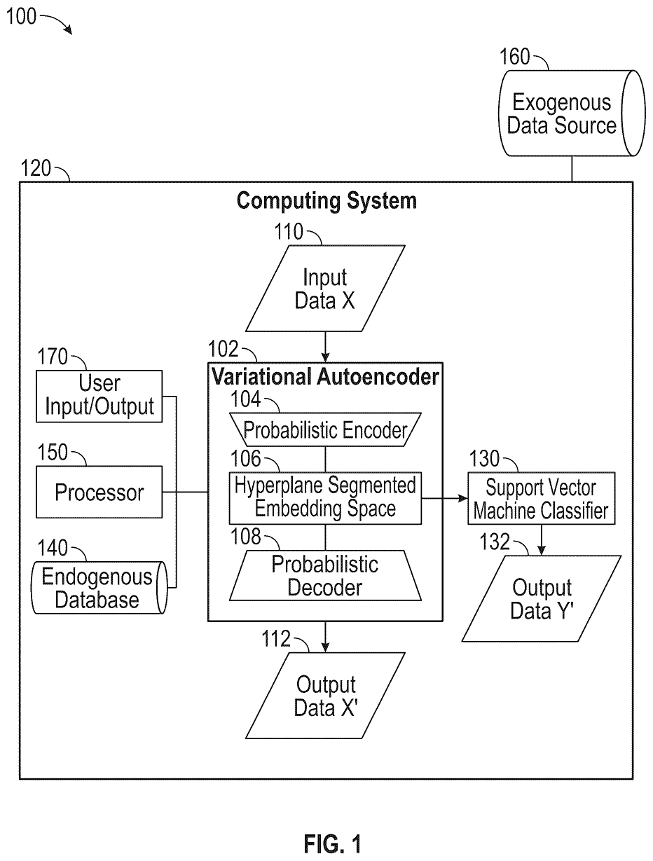

FIG. 1 depicts a system 100 for classifying encoded data. The system 100 may include a computing system 120. The computing system 120 may include one or more processors 150 and one or more user input/output (I/O) devices 170 communicatively coupled (e.g., by one or more wired or wireless network communication protocols and/or interface(s)) to one or more databases 140, a variational autoencoder (VAE) 102, and a linear support vector machine (SVM) 130. The one or more processors 150 may be configured control some or all of the functionality of system 100 described herein. In some embodiments, the one or more processors may be provided as a single processor, a plurality of local processors, and/or a plurality of distributed processors. Though shown separately from probabilistic encoder 104, probabilistic decoder 108, and support vector machine classifier 130, the one or more processors 150 may provide processing functionality for one or more of said components. Additionally or alternatively, the one or more processors 150 may provide other functionality as described herein, such as processing user inputs, controlling system settings, curating data to be used by the VAE 102 and/or SVM 130 for training and/or classification, labeling and/or formatting data to be used by the VAE 102 and/or SVM 130 for training, updating settings of the VAE 102 and/or SVM 130 during training, and/or generating explainability data such as by computing a minimum sufficient adjustment for a datum to be reclassified into a different class as explained herein.

The one or more processors 150 may be configured to cause the VAE to process input data, for instance from the database 140, to generate encoded data in an embedding space and to generate decoded data using the encoded data, as described further below. The VAE 102 may be trained by causing the VAE to perform the aforementioned encoding and decoding steps, and by iteratively updating one or more configurations of probabilistic encoder 104 and/or probabilistic decoder 108 in a manner configured to minimize the loss function of VAE 102. In some embodiments, the VAE is trained according to a semi-supervised training process. In some embodiments, the VAE may be initially trained using unlabeled data and retrained using labeled data. In some embodiments, the VAE may be trained using data having labels representing record type classifications. In some embodiments, the VAE may be trained using data not having labels representing record type classifications. In some embodiments the VAE can begin to be trained using data labeled only based on the data schema, additional labels may be requested as user inputs after initially encoding the input data, and the VAE can be retrained. In some embodiments, the VAE may be trained to classify anomalies in the input data. The one or more processors 150 may further be configured to cause the linear SVM in communication with the embedding space of the VAE to classify the encoded data, wherein classifying the encoded data comprises determining one or more hyperplanes separating classes of encoded data in the embedding space, as described further below.

The VAE 102 may include a probabilistic encoder 104 and a probabilistic decoder 108. The probabilistic encoder 104 and probabilistic decoder 108 may be neural networks configured to perform various processing operations on received input data, respectively, as described below. The probabilistic encoder 104 may be configured to receive input data X 110 from a database 140 endogenous to computing system 120 or from one or more exogenous data sources 160 communicatively coupled (e.g., by one or more wired or wireless network communication protocols and/or interface(s)) with the computing system 120. The probabilistic encoder 104 may be configured to generate, based on the input data, encoded data in an embedding space 106. As described herein, VAE 102 may be trained and configured such that the encoded data in the embedding space 106 comprises a plurality of clusters that are separable by a hyperplane such that the encoded data may be classified (e.g., by SVM 130) into a first class of encoded data and a second class of encoded data.

The embedding space 106 may be a lower-dimensional space into which the input data X is compressed for performing one or more machine learning operations (e.g., decoding and/or classification). Encoding the data into the lower dimensional embedding space may include reducing the dimensionality of the input data, or in other words, reducing the number of features that describe the input data to generate a vector representation of the data in an embedding space. Various processes for feature reduction are known in the art, including feature selection, in which features are selected to be preserved or feature extraction, in which new features are created based on the features of the input data. The probabilistic decoder 108 can be configured to decode the data from the embedding space to generate decoded output data X′ 112. As such, the probabilistic decoder 108 can be configured to take as an input the encoded/compressed data from the embedding space 106 and to generate decompressed/decoded data based on the encoded input. The decoded output data X′ thus includes a reconstruction of the input data X 110.

Based on the encoded and decoded data, the VAE 102 can be configured to compute a loss function. The loss function of VAE 102 may define a difference between the input and the output of the VAE and may include at least three loss terms: a generative loss term, a latent loss term, and a hinge-loss term. As such, the overall loss is the combination of hinge loss, generative loss, and latent loss. By training the VAE 102 by minimizing generative loss, the difference between the input data/training data and the decoded output data can be minimized. As such, the VAE 102 can be configured/updated during training to increase the efficiency and accuracy of the encoding-decoding scheme of the VAE 102 based on the generative loss term.

By configuring/training the VAE 102 by minimizing the latent loss, deviation from the desired distribution can be minimized. Training the VAE 102 by minimizing minimize the latent loss term can encourage the VAE 102 to encode data such that points that are near each other in the latent space are similar to each other once decoded. In some examples, the VAE 102 can be configured and/or updated during training based on the latent loss to regularize a covariance matrix and a mean of a distribution, wherein the covariance matrix and the mean of the distribution are returned by the probabilistic encoder. The regularization of the covariance matrix and the mean of the distribution can include regularization to a Gaussian distribution. It should be understood, however, that any analytic distribution can be used, such as a uniform distribution, exponential distribution, Poisson distribution, binomial distribution, etc. In some examples, the latent-loss term may include a Kullback-Leibler divergence loss term.

Further, by configuring/training the VAE 102 by minimizing the hinge loss term, the VAE 102 can be configured to maximize a margin between a first class of encoded data on a first side of the hyperplane and a second class of encoded data on a second side of the hyperplane, as described above. As such, by configuring/training the VAE 102 to minimize the hinge loss term, the VAE 102 can be configured to separate data encoded in the embedding space by one or more hyperplanes.

In some examples, the VAE 102 may be configured to separate the data by one or more static hyperplanes or one or more adaptive hyperplanes. If the VAE 102 is configured to separate the data by one or more static hyperplanes, all interclass decision boundaries may be defined prior to training the VAE 102. If the VAE 102 is configured to separate the data by one or more adaptive hyperplanes, interclass decision boundaries can be fit to embeddings and refined while the VAE is trained. Configurations implementing adaptive hyperplanes may be more robust but can be more complicated to train.

By separating the data by one or more hyperplanes in the embedding space by minimizing the hinge-loss term as described above, the VAE 102 can configure the encoded data such that it can be readily classified into one or more classes by a linear SVM 130 to generate classified output data Y′ 132. As such, a linear SVM 130 may be configured to classify encoded data in the embedding space into a first class of encoded data in the embedding space and a second class of encoded data in the embedding space, wherein the first class of encoded data and the second class of encoded data are separated in the embedding space by a hyperplane. As noted above, the VAE 102 can be trained by minimizing a hinge loss term to maximize a margin between the first class of the encoded data and the second class of the encoded data for classification by the SVM 130. The linear SVM 130 can be configured to determine the hyperplane separating the first class of data from the second class of data. In some embodiments, the SVM is also trained according to a semi-supervised training process. In some embodiments, the SVM may be initially trained using unlabeled data and retrained using labeled data. In some embodiments, the SVM may be trained using data having labels representing record type classifications. In some embodiments, the SVM may be trained using data not having labels representing record type classifications. In some embodiments the SVM can begin to be trained using data labeled only based on the data schema, and additional labels may be requested as user inputs after initially encoding the input data, and the SVM can be retrained. In some embodiments, the SVM is trained in combination with the VAE.

The one or more processors 150 may further be configured to generate an explainability output, wherein the explainability output comprises an indication of a minimum sufficient adjustment to one or more variables in the input data associated with a datum embedded by probabilistic encoder 104 and classified by the SVM 130 into the first class that would cause the VAE 102 and SVM 130 to re-encode and re-reclassify the corresponding re-encoded datum into the second class.

In some embodiments, identifying the minimum sufficient adjustment to the one or more variables in the input data associated with the encoded/embedded datum may include: ranking each variable in the input data associated with an encoded/embedded datum based on the impact each respective variable has on moving the encoded/embedded datum toward or away from a hyperplane separating two classes of data; selecting a first variable from a predefined number of changeable variables with the highest ranking contribution to a respective classification, and changing that variable; and repeating the previous two steps until the classification of the respective datapoint is changed.

In some embodiments, identifying the minimum sufficient adjustment to the one or more variables in the input data associated with the first encoded/embedded datum may include adjusting a randomly selected set of variables in the input data associated with an encoded/embedded datum in a randomly selected direction, and progressively increasing the magnitude of the adjustment until a sufficient-magnitude adjustment to the variable(s) is made to cause reclassification of the encoded/embedded datum. In some embodiments, identifying the minimum sufficient adjustment may include adjusting one or more variables in the input data associated with an encoded/embedded datum in a plurality of different directions and/or dimensions by a predefined magnitude, thus forming a multi-dimensional geometry (e.g., a “cube” or “sphere”) around the original unadjusted encoded/embedded datum, and determining whether any such adjustment is sufficient to cause reclassification.

The one or more processors 150 may further be configured to train or retrain the VAE 102 by causing the VAE 102 to identify one or more uncertain datum in the embedding space and requesting a user input comprising a label for the one or more uncertain datum. The one or more uncertain datum may include an unlabeled datum nearest to a hyperplane separating the first class of data and second class of data. The one or more processors 150 may be configured to retrain the VAE 102 based on the label for the uncertain datum. Retraining the VAE 102 may result in the first and second class of data from a first dataset being separated by a hyperplane in embedding space different from the hyperplane separating the first and second class of data prior to retraining the VAE 102.

Additionally, the one or more processors 150 may be configured to cause the VAE 102 to generate synthetic training data, and to prompt a user to label one or more datum in the synthetic training data. The one or more processors 150 may be configured to retrain the VAE 102 based on the labels for the synthetic data, and retraining the VAE may result in the first and second class of data being separated by a hyperplane in embedding space different from a hyperplane separating the encoded data prior to retraining the VAE. The one or more processors 150 may further be configured to detect when an update is required (e.g., based on data drift) and issue an alert indicating that the VAE 102 needs to be retrained.

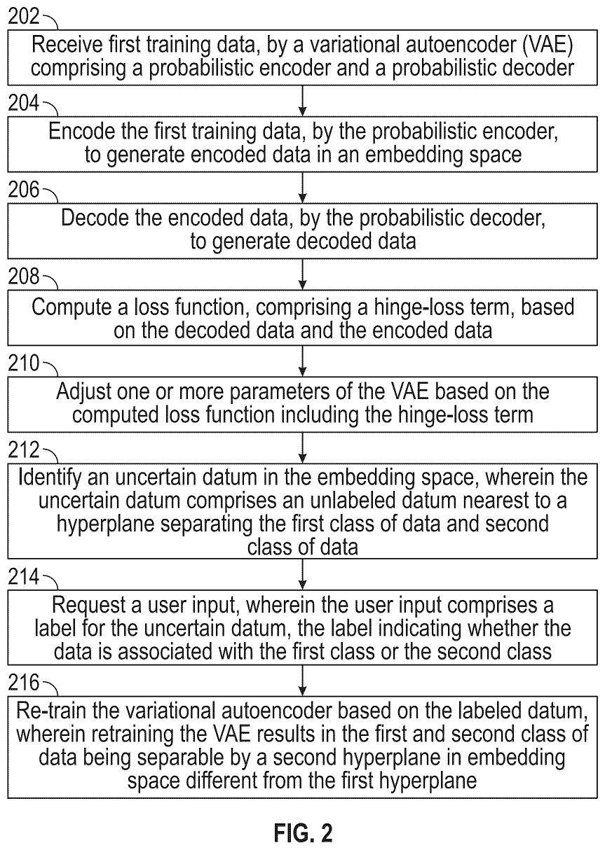

FIG. 2 illustrates an exemplary method 200 for training a VAE, such as VAE 102 described above with reference to the system 100 of FIG. 1, according to one or more examples. The method 200 can begin at step 202, wherein step 202 can include receiving first training data, by a variational autoencoder (VAE) comprising a probabilistic encoder and a probabilistic decoder. The method 200 can be applied using any one of a variety of datasets. For instance, the training data may include census data (e.g., to predict income class), cartographic data (e.g., for predicting the cover type of forests), transaction data (e.g., to detect credit card transaction fraud), or the MNIST dataset. It should be understood that the aforementioned list is meant to be exemplary, and a wide variety of other training data may be used without deviating from the scope of this disclosure. As described above, in some embodiments, the input data may include any of string data, image data, time-series data, or any combination thereof. In some embodiments, the VAE may be initially trained using unlabeled data and retrained using labeled data. In some embodiments, the VAE may be trained using data having labels representing record type classifications. In some embodiments, the VAE may be trained using data not having labels representing record type classifications. In some embodiments the VAE can begin to be trained using data labeled only based on the data schema, additional labels may be requested as user inputs after initially encoding the input data, and the VAE can be retrained. In some embodiments, the VAE may be trained to classify anomalies in the input data.

After receiving the first training data at step 202, the method 200 may proceed to step 204. Step 204 can include encoding the first training data, by the probabilistic encoder, to generate encoded data in an embedding space. As described above, generating encoded data in an embedding space may include compressing the first training data by selecting or extracting features from the training data to reduce a number of features that describe the training data in a lower-dimensional embedding space.

After encoding the training data at step 204, the method 200 may proceed to step 206. Step 206 can include decoding the encoded data, by the probabilistic decoder, to generate decoded data. As described above, the decoded data can include a reconstruction of the training data. For instance, the training data received at step 202 may include an image of a human face. Decoding the encoded data at step 206 may include reconstructing the image of the human face using encoded (e.g., compressed) data from the embedding space. Any difference between the human face depicted in the training data prior to encoding the training data and the human face depicted in the decoded data generated at step 206 can be represented by a loss function, as described below.

After decoding the encoded data, by the probabilistic decoder, to generate decoded data at step 206, the method 200 can proceed to step 208. Step 208 can include computing a loss function, the loss function comprising a hinge-loss term, based on the decoded data and the encoded data. As described above with respect to FIG. 1, the loss function can include three loss terms: a generative loss term, a latent loss term, and the hinge-loss term. Each of the respective loss terms included in the loss function may serve a respective purpose. For instance, minimizing the generative loss term can train the VAE to minimize the difference between the training data and the decoded output data, thus increasing the efficiency and accuracy of the encoding-decoding scheme. Minimizing the latent loss term can train the VAE to enforce normal distributions of encoded data within the embedding space. As such, minimizing the latent loss term can encourage the VAE to encode data such that points that are near each other in the latent space are similar to each other once decoded.

As described above with reference to FIG. 1, in some examples, minimizing the latent loss term can train the VAE to regularize a covariance matrix and a mean of a distribution, wherein the covariance matrix and the mean of the distribution are returned by the probabilistic encoder. The regularization of the covariance matrix and the mean of the distribution can include regularization to a Gaussian distribution. In some examples, the latent-loss term may include a Kullback-Leibler divergence loss term. Minimizing the hinge-loss term can train the VAE to manipulate the distribution of the encoded data in the embedding space by separating the encoded data in the embedding space by one or more hyperplanes.

After computing a loss function comprising a hinge-loss term, based on the decoded data and the encoded data at step 208, the method 200 can proceed to step 210. Step 210 can include adjusting one or more parameters of the VAE based on the computed loss function including the hinge-loss term. Adjusting the one or more parameters of the VAE based on the hinge-loss term (e.g., to train the VAE by minimizing the hinge-loss term) can configure the VAE to separate data in the embedding space by a hyperplane. Adjusting the one or more parameters of the VAE to train the VAE by minimizing the hinge-loss term can train the VAE to maximize a margin between a first class of encoded data on a first side of the hyperplane and a second class of encoded data on a second side of the hyperplane.

After adjusting one or more parameters of the VAE based on the computed loss function including the hinge-loss term at step 210, the method 200 can proceed to step 212. Step 210 can include identifying an uncertain datum in the embedding space, wherein the uncertain datum comprises an unlabeled datum nearest to a hyperplane separating the first class of data and second class of data. After identifying an uncertain datum in the embedding space at step 212, the method 200 can proceed to step 214. Step 214 can include requesting a user input, wherein the user input comprises a label for the uncertain datum. The label may indicate whether the data is associated with the first class or the second class of data encoded in the embedding space.

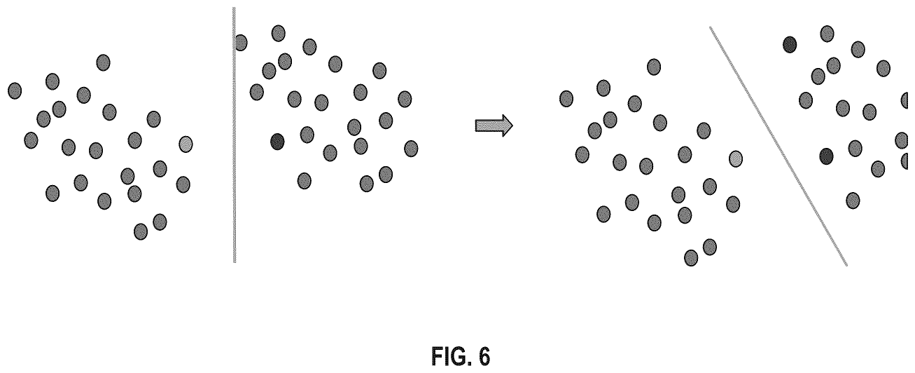

After requesting a user input at step 214, the method 200 can proceed to step 216. Step 216 can include retraining the VAE based on the labeled datum. Retraining the VAE may result in the first and second class of data being separable by a second hyperplane in embedding space different from the first hyperplane. In other words, step 216 can include encoding, by the VAE, the first training data into the embedding space, wherein the first training data includes a class label for the uncertain datum identified at step 212. Retraining the VAE with data including the user provided class label may cause a hyperplane separating data classes in the embedding space to shift, for instance, as shown in FIG. 6.

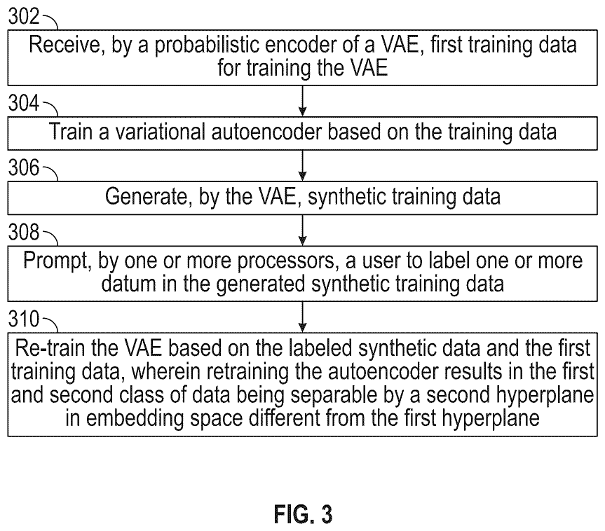

FIG. 3 illustrates an exemplary method 300 for generating and labeling synthetic training data using a VAE, such as VAE 102, according to one or more examples. The method 300 can begin at step 302, wherein step 302 can include receiving, by a probabilistic encoder of a VAE, first training data for training the VAE. The training data may include any of the training data described above with reference to the method 200 illustrated in FIG. 2. As such, the training data may include census data (e.g., to predict income class), cartographic data (e.g., for predicting the cover type of forests), transaction data (e.g., to detect credit card transaction fraud), or the MNIST dataset. As noted above, it should be understood that the aforementioned list is meant to be exemplary and a wide variety of other training data may be used without deviating from the scope of this disclosure.

After receiving the training data at step 302, the method 300 can proceed to step 304. Step 304 may include training a VAE based on the training data received at step 302. The VAE (for instance VAE 102 of system 100) may be trained by minimizing a loss function comprising a hinge-loss term, as described above. The VAE may be trained, for instance, according to the method 200 set forth above with reference to FIG. 2. As such, training the VAE at step 304 may include causing the VAE to process input data, for instance from a database, to train a probabilistic encoder of the VAE to generate encoded data in an embedding space and to train a probabilistic decoder to generate decoded data using the encoded data. Training the VAE may include computing a loss function, comprising a generative loss term, a latent loss term, and a hinge-loss term, based on the decoded data and the encoded data and adjusting one or more parameters of the VAE based on the computed loss function including the generative loss term, latent loss term, and hinge-loss term.

As described above, adjusting the one or more parameters of the VAE based on the hinge-loss term can configure the VAE to separate data in the embedding space by a hyperplane. Adjusting the one or more parameters of the VAE based on the hinge-loss term may further configure the VAE to maximize a margin between a first class of encoded data on a first side of the hyperplane and a second class of encoded data on a second side of the hyperplane. Thus, training the VAE at step 304 may configure the VAE to generate encoded data in an embedding space separated by one or more hyperplanes.

After training the VAE at step 304, the method 300 can proceed to step 306. Step 306 can include generating, by the trained VAE synthetic training data. The synthetic training data may be generated using the decoder of the VAE. The synthetic training data may include a corpus of training data having the required data characteristics for training one or both of a VAE and linear SVM. The synthetic training data may have characteristics similar to the training data received at step 304.

After generating the synthetic training data at step 306, the method 300 can proceed to step 308. Step 308 can include prompting, by one or more processors, a user to label one or more datum in the generated synthetic training data. The user input may be provided by one or more input/output devices in communication with the one or more processors (e.g., by one or more wired or wireless network communication protocols and/or interface(s)), for instance input/output device 170 and processor 150 of FIG. 1. The user input may include a label indicative of a class associated with a respective datum/data point.

After prompting, by one or more processors, a user to label one or more datum in the generated synthetic training data at step 306, the method 300 can proceed to step 308. Step 308 can include re-training the VAE based on the labeled synthetic data and the first training data. Retraining the VAE can result in a first and second class of the training data received at step 302 being separated by a hyperplane in embedding space different from the one or more hyperplanes described above with reference to step 304.

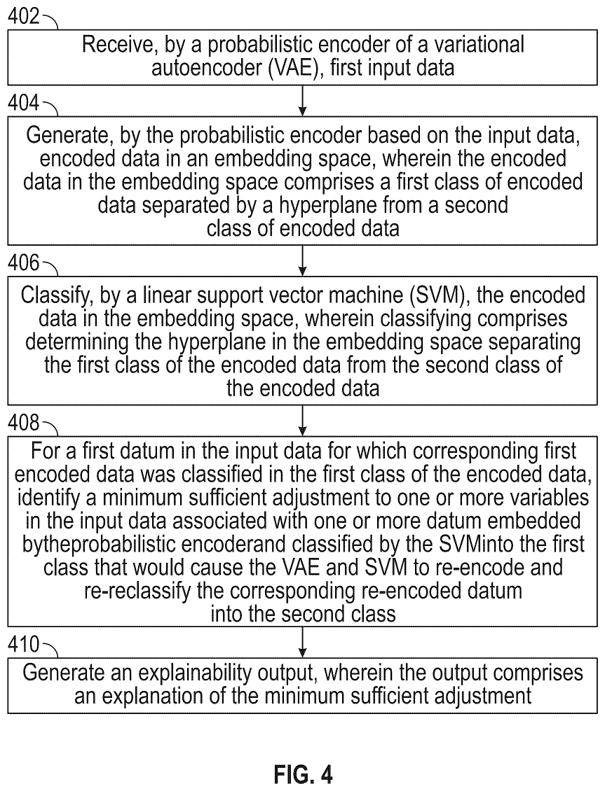

FIG. 4 illustrates a method 400 for classifying encoded data using a linear support vector machine according to one or more examples. The method 400 can begin at step 402, which can include receiving, by a probabilistic encoder of a variational autoencoder (VAE), such as VAE 102 described above with reference to FIG. 1, first input data. The first input data may include any of the data described above with reference to the methods 200 and 300 illustrated in FIGS. 2 and 3, respectively. As such, the data may include census data (e.g., to predict income class), cartographic data (e.g., for predicting the cover type of forests), transaction data (e.g., to detect credit card transaction fraud), or the MNIST dataset. As noted above, it should be understood that the aforementioned list is meant to be exemplary and a wide variety of other training data may be used without deviating from the scope of this disclosure.

After receiving the first input data at step 402, the method 400 can proceed to step 404. Step 404 can include generating, by the probabilistic encoder based on the input data, encoded data in an embedding space. The encoded data in the embedding space can include a first class of encoded data separated by a hyperplane from a second class of encoded data. As described above, training the VAE may include computing a loss function, comprising a hinge-loss term, based on the decoded data and the encoded data and adjusting one or more parameters of the VAE based on the computed loss function including the hinge-loss term. Further, adjusting the one or more parameters of the VAE based on the hinge-loss term can configure the VAE to separate data in the embedding space by a hyperplane. Adjusting the one or more parameters of the VAE based on the hinge-loss term (e.g., to minimize the hinge loss) may configure the VAE to maximize a margin between a first class of encoded data on a first side of the hyperplane and a second class of encoded data on a second side of the hyperplane.

After generating, by the probabilistic encoder based on the input data, encoded data in an embedding space at step 404, the method 400 can proceed to step 406. Step 406 can include classifying, by a linear support vector machine (SVM) such as the linear SVM 130 described above with reference to FIG. 1, the encoded data in the embedding space. Classifying may include determining the hyperplane in the embedding space separating the first class of the encoded data from the second class of the encoded data.

After classifying, by a linear support vector machine (SVM), the encoded data in the embedding space at step 406, the method 400 can proceed to step 408. Step 408 can include, for a first datum in the input data for which corresponding first encoded data was classified in the first class of the encoded data, identifying a minimum sufficient adjustment to one or more variables in the input data associated with a datum embedded by the probabilistic encoder (e.g., probabilistic encoder 104) and classified by the SVM (e.g., SVM 130) into the first class that would cause the VAE (e.g., VAE 102) and SVM (e.g., SVM 130) to re-encode and re-reclassify the corresponding re-encoded datum into the second class.

As described above, identifying the minimum sufficient adjustment to one or more variables associated in the input data with the first encoded/embedded datum may include: ranking each variable associated with an encoded/embedded datum based on the impact each respective variable has on moving the encoded/embedded datum toward or away from a hyperplane separating two classes of data; selecting a first variable from a predefined number of changeable variables with the highest ranking contribution to a respective classification, and changing that variable; and repeating the previous two steps until the classification of the respective embedded datum is changed.

In some embodiments, identifying the minimum sufficient adjustment to the one or more variables associated in the input data with the first embedded datum may include adjusting a randomly selected set of variables in the input data associated with an encoded/embedded datum in a randomly selected direction, and progressively increasing the magnitude of the adjustment until a sufficient-magnitude adjustment to the variable(s) is made to cause reclassification of the encoded/embedded datum. In some embodiments, identifying the minimum sufficient adjustment to one or more variables associated in the input data with the first datum may include adjusting one or more variables in the input data associated with an encoded/embedded datum in a plurality of different directions and/or dimensions by a predefined magnitude, thus forming a multi-dimensional geometry (e.g., a “cube” or “sphere”) around the original unadjusted encoded/embedded datum, and determining whether any such adjustment is sufficient to cause reclassification.

After identifying a minimum sufficient adjustment to the one or more variables associated in the input data with the first encoded/embedded datum at step 408, the method 400 can proceed to step 410. Step 410 can include generating an explainability output. The explainability output may be generated by one or more processors, such as the one or more processors 150 and output to a user using input/output device 170, described above with reference to FIG. 1. The explainability output can include an explanation of the minimum sufficient adjustment to one or more variables in the input data associated with a datum embedded by the probabilistic encoder (e.g., probabilistic encoder 104) and classified by the SVM (e.g., SVM 130) into the first class that would cause the VAE (e.g., VAE 102) and SVM (e.g., SVM 130) to re-encode and re-reclassify the corresponding re-encoded datum into the second class. A generated output may further include the classification generated by the linear support vector machine (SVM) at step 406. The output may include, for instance, a visual (e.g., textual or graphical) or audio representation of the classification and/or the explanation of the minimum sufficient adjustment.

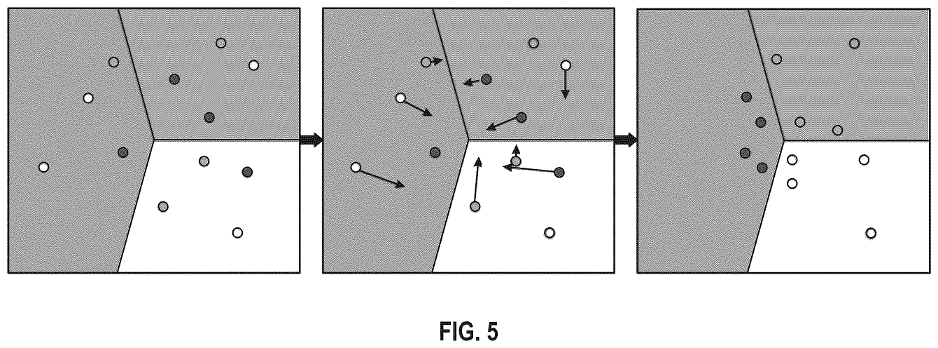

FIG. 5 illustrates an exemplary hyperplane segmented embedding space generated by a probabilistic encoder of a VAE according to one or more examples. The exemplary hyperplane segmented embedding space illustrated in FIG. 5 includes a plurality of data points/datum. The plurality of data points in the exemplary hyperplane segmented embedding space depicted in FIG. 5 include three distinct classes of data (represented in FIG. 5 by the different colors associated with the respective data points: green, blue, and white). The embedding space on the far left of FIG. 5 depicts an initial encoding of an exemplary input data set. As shown the data points within the embedding space are not linearly separated from one another by hyperplanes within the embedding space. The embedding space depicted in the middle of FIG. 5 represents how losses from initial embeddings in the wrong class domain are backpropagated, causing the model to learn the desired embedding structure. Finally, the embedding space shown on the far right of FIG. 5 represents an exemplary desired embedding structure, wherein each respective data point encoded by the VAE is placed within the correct class domain and each class is separated by a linear hyperplane. As described above, FIG. 6 illustrates an exemplary hyperplane separating data classes in an embedding space shifting in response to a user input according to one or more examples.

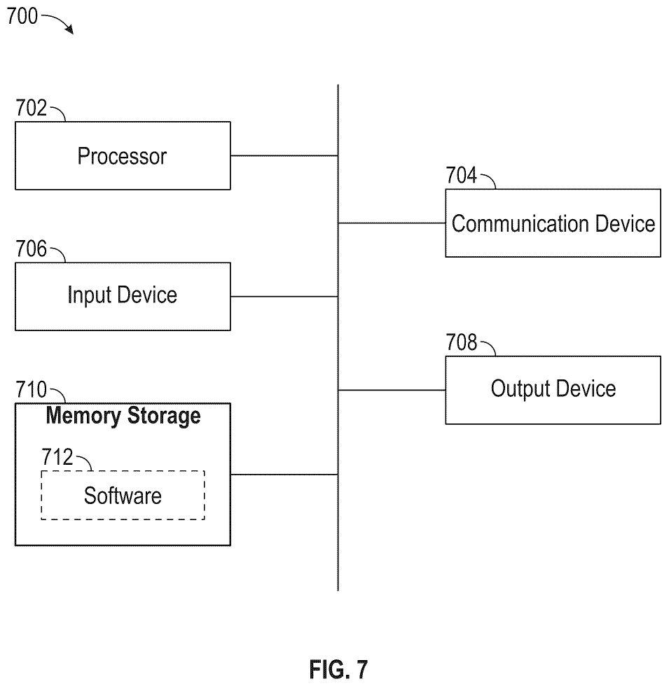

FIG. 7 depicts an exemplary computing device 700, in accordance with one or more examples of the disclosure. Device 700 can be a host computer connected to a network. Device 700 can be a client computer or a server. As shown in FIG. 7, device 700 can be any suitable type of microprocessor-based device, such as a personal computer, workstation, server, or handheld computing device (portable electronic device) such as a phone or tablet. The device can include, for example, one or more of processors 702, input device 706, output device 708, storage 710, and communication device 704. Input device 706 and output device 708 can generally correspond to those described above and can either be connectable or integrated with the computer.

Input device 706 can be any suitable device that provides input, such as a touch screen, keyboard or keypad, mouse, or voice-recognition device. Output device 708 can be any suitable device that provides output, such as a touch screen, haptics device, or speaker.

Storage 710 can be any suitable device that provides storage, such as an electrical, magnetic, or optical memory, including a RAM, cache, hard drive, or removable storage disk. Communication device 704 can include any suitable device capable of transmitting and receiving signals over a network, such as a network interface chip or device. The components of the computer can be connected in any suitable manner, such as via a physical bus or wirelessly.

Software 712, which can be stored in storage 710 and executed by processor 702, can include, for example, the programming that embodies the functionality of the present disclosure (e.g., as embodied in the devices as described above).

Software 712 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 710, that can contain or store programming for use by or in connection with an instruction execution system, apparatus, or device.

Software 712 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport readable medium can include, but is not limited to, an electronic, magnetic, optical, electromagnetic, or infrared wired or wireless propagation medium.

Device 700 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Device 700 can implement any operating system suitable for operating on the network. Software 712 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

### Adversarial Machine Learning Resistance

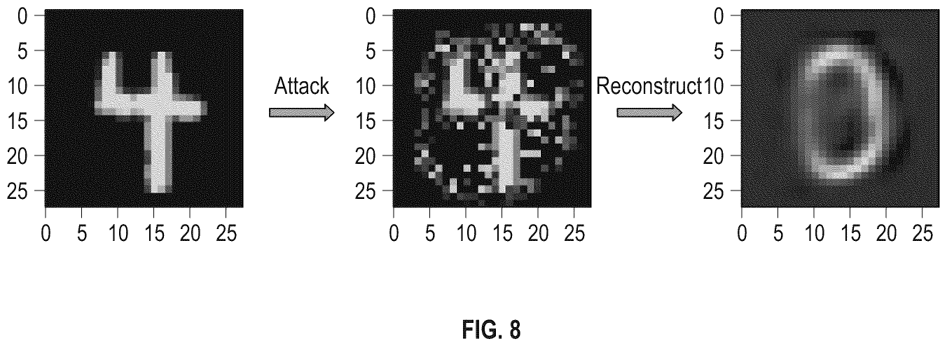

One of the benefits provided by the systems and methods described herein is a resistance to adversarial machine learning attacks. FIG. 8 illustrates how an adversarial attack changes the reconstruction of an encoded image. As shown, the visual representation of an MNIST dataset is changed from “Class 4” to “Class 0” during reconstruction/decoding. In essence, an adversarial attack with respect to image data tries to change as few pixels as possible to alter the reconstruction to achieve a desired result. The systems described herein may exhibit enhanced resilience against adversarial attacks due to the explainability feature described throughout.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

1. A method for training a machine learning model, the method comprising:
receiving first training data, by a variational autoencoder (VAE) comprising a probabilistic encoder and a probabilistic decoder; and
encoding the first training data, by the probabilistic encoder, to generate encoded data in an embedding space;
decoding the encoded data, by the probabilistic decoder, to generate decoded data;
computing a loss function, comprising a hinge-loss term, based on the decoded data and the encoded data; and
adjusting one or more parameters of the VAE based on the computed loss function including the hinge-loss term.

2. The method of claim 1, wherein adjusting the one or more parameters of the VAE based on the hinge-loss term configures the VAE to separate data in the embedding space by a hyperplane.

3. The method of claim 2, wherein adjusting the one or more parameters of the VAE based on the hinge-loss term configures the VAE to maximize a margin between a first class of encoded data on a first side of the hyperplane and a second class of encoded data on a second side of the hyperplane.

4. The method of claim 1, wherein the loss function further comprises a generative-loss term and a latent-loss term.

5. The method of claim 4, wherein adjusting the one or more parameters of the VAE based on the computed loss function comprises adjusting the one or more parameters of the VAE based on the generative-loss term to minimize the difference between the training data and the decoded output data.

6. The method of claim 4, wherein the generative-loss term comprises an L2-loss term, wherein the L2-loss term comprises a squared difference between a decoded output data and the training data.

7. The method of claim 4, wherein adjusting the one or more parameters of the VAE based on the computed loss function comprises adjusting the one or more parameters of the VAE based on the latent-loss term to regularize a covariance matrix and a mean of a distribution, wherein the covariance matrix and the mean of the distribution are returned by the probabilistic encoder.

8. The method of claim 7, wherein the regularization of the covariance matrix and the mean of the distribution comprises regularization to a Gaussian distribution.

9. The method of claim 7, wherein the latent-loss term comprises a Kullback-Leibler divergence loss term.

10. The method of claim 1, further comprising: identifying an uncertain datum in the embedding space, wherein the uncertain datum comprises an unlabeled datum nearest to a hyperplane separating the first class of data and second class of data; and requesting user input, wherein the user input comprises a label for the uncertain datum.

11. The method of claim 10, further comprising: retraining the VAE based on the user input comprising the label for the uncertain datum, wherein retraining the VAE results in the first and second class of data being separated by a second hyperplane in embedding space different from the first hyperplane.

12. The method of claim 1, further comprising:
generating, by the variational autoencoder, synthetic training data; and
prompting, by one or more processors, a user to label one or more datum in the generated synthetic data.

13. The method of claim 12, further comprising: retraining the VAE based on the labeled synthetic training data and the first input data.

14. The method of claim 13, wherein retraining the VAE results in the first and second class of data being separated by a second hyperplane in embedding space different from the first hyperplane.

15. The method of claim 1, further comprising configuring a linear support vector machine (SVM) to classify encoded data in the embedding space into a first class of encoded data in the embedding space and a second class of encoded data in the embedding space,
wherein the first class of encoded data and the second class of encoded data are separated in the embedding space by a hyperplane, and
wherein the VAE is configured based on minimizing the hinge-loss term to maximize a margin between the first class of the encoded data and the second class of the encoded data for classification by the SVM.

16. The method of claim 15, wherein the linear SVM is configured to determine the hyperplane separating the first class of data from the second class of data.

17. The method of claim 15, further comprising: generating, by one or more processors, an output, wherein the output comprises an explanation of a minimum sufficient adjustment to one or more variables associated in the input data with a first encoded datum classified by the SVM in the first class that would cause the VAE to re-encode and the SVM to re-classify the re-encoded datum in the second class.

18. A system for training a machine learning model, the system comprising one or more processors and a memory storing one or more computer programs including instructions, which when executed by the one or more processors, cause the system to:
receive first training data, by a variational autoencoder (VAE) comprising a probabilistic encoder and a probabilistic decoder; and
encode the first training data, by the probabilistic encoder, to generate encoded data in an embedding space;
decode the encoded data, by the probabilistic decoder, to generate decoded data;
compute a loss function, comprising a hinge-loss term, based on the decoded data and the encoded data; and
adjust one or more parameters of the VAE based on the computed loss function including the hinge-loss term.

19. A non-transitory computer-readable storage medium for training a machine learning model, the non-transitory computer-readable storage medium storing instructions configured to be executed by one or more processors of a system to cause the system to:
receive first training data, by a variational autoencoder (VAE) comprising a probabilistic encoder and a probabilistic decoder; and
encode the first training data, by the probabilistic encoder, to generate encoded data in an embedding space;
decode the encoded data, by the probabilistic decoder, to generate decoded data;
compute a loss function, comprising a hinge-loss term, based on the decoded data and the encoded data; and
adjust one or more parameters of the VAE based on the computed loss function including the hinge-loss term.

20. A system for classifying encoded data, the system comprising one or more processors and a memory storing one or more computer programs including instructions, which when executed by the one or more processors, cause the system to:
receive, by a probabilistic encoder of a variational autoencoder (VAE), first input data;
generate, by the probabilistic encoder based on the input data, encoded data in an embedding space, wherein the encoded data in the embedding space comprises a first class of encoded data separated by a hyperplane from a second class of encoded data; and
classify, by a linear support vector machine (SVM), the encoded data in the embedding space wherein classifying the encoded data comprises determining the hyperplane in the embedding space separating the first class of the encoded data from the second class of the encoded data.

21. The system of claim 20, wherein the one or more processors are configured to:
for a first encoded datum classified in the first class of the encoded data, identify a minimum sufficient adjustment to one or more variables associated in the first input data with the first encoded datum, the minimum sufficient adjustment configured to cause the VAE to re-encode the first encoded datum and the SVM to re-classify the re-encoded datum in the second class.

22. The system of claim 21, wherein identifying the minimum sufficient adjustment to the first datum comprises:
ranking each variable associated with the encoded datum based on an amount that each respective variable causes the datum to move toward the hyperplane separating the first and second classes of data; and changing the variable with the highest ranking.

23. The system of claim 20, wherein the VAE is trained by: encoding training data, by a probabilistic encoder, to generate encoded data in an embedding space; decoding the encoded data, by the probabilistic decoder, to generate decoded data; computing a loss function, comprising a hinge-loss term, based on the decoded data and the encoded data; and adjusting one or more parameters of the VAE based on the computed loss function including the hinge-loss term.

24. The system of claim 23, wherein adjusting the one or more parameters of the VAE based on the hinge-loss term configures the VAE to separate data in the embedding space by a hyperplane.

25. The system of claim 23, wherein adjusting the one or more parameters of the VAE based on the hinge-loss term configures the VAE to maximize a margin between a first class of encoded data on a first side of the hyperplane and a second class of encoded data on a second side of the hyperplane.

26. The system of claim 23, wherein the loss function further comprises a generative-loss term and a latent-loss term.

27. The system of claim 26, wherein adjusting the one or more parameters of the VAE based on the computed loss function comprises adjusting the one or more parameters of the VAE based on the generative-loss term to minimize the difference between the training data and the decoded output data.

28. The system of claim 26, wherein the generative-loss term comprises an L2-loss term, wherein the L2-loss term comprises a squared difference between a decoded output data and the training data.

29. The system of claim 26, wherein adjusting the one or more parameters of the VAE based on the computed loss function comprises adjusting the one or more parameters of the VAE based on the latent-loss term to regularize a covariance matrix and a mean of a distribution, wherein the covariance matrix and the mean of the distribution are returned by the probabilistic encoder.

30. The system of claim 29, wherein the regularization of the covariance matrix and the mean of the distribution comprises regularization to a Gaussian distribution.

31. The system of claim 26, wherein the latent-loss term comprises a Kullback-Leibler divergence loss term.

32. The system of claim 23, wherein the VAE is further trained by:
identifying an uncertain datum in the embedding space, the uncertain datum comprising an unlabeled datum nearest to the hyperplane separating the first class of data and second class of data;
requesting user input, the user input comprising a label for the uncertain datum; and
retraining the VAE based on the label for the uncertain datum, retraining the VAE resulting in the first and second class of data being separated by a second hyperplane in embedding space different from the first hyperplane.

33. The system of claim 20, wherein the one or more processors are further configured to:
generate, by the variational autoencoder, synthetic training data; and
prompt a user to label one or more datum in the generated synthetic data.

34. The system of claim 33, wherein the one or more processors are further configured to:
retrain the VAE based on the labeled synthetic training data and the first input data.

35. The system of claim 34, wherein retraining the VAE results in the first and second class of data being separated by a second hyperplane in embedding space different from the first hyperplane.

36. The system of claim 20, wherein the one or more processors are further configured to cause the system to: generate an output, wherein the output comprises an explanation of a minimum sufficient adjustment to one or more variables associated in the first input data with a first encoded datum to cause the VAE to re-encode the first encoded datum and the SVM to re-classify the re-encoded datum in the second class.

37. A method for classifying encoded data, the method comprising:
receiving, by a probabilistic encoder of a variational autoencoder (VAE), first input data;
generating, by the probabilistic encoder based on the input data, encoded data in an embedding space, wherein the encoded data in the embedding space comprises a first class of encoded data separated by a hyperplane from a second class of encoded data; and
classifying, by a linear support vector machine (SVM), the encoded data in the embedding space wherein classifying comprises determining the hyperplane in the embedding space separating the first class of the encoded data from the second class of the encoded data.

38. A non-transitory computer-readable storage medium for training a machine learning model, the non-transitory computer-readable storage medium storing instructions configured to be executed by one or more processors of a system to cause the system to:
receive, by a probabilistic encoder of a variational autoencoder (VAE), first input data;
generate, by the probabilistic encoder based on the input data, encoded data in an embedding space, wherein the encoded data in the embedding space comprises a first class of encoded data separated by a hyperplane from a second class of encoded data; and
classify, by a linear support vector machine (SVM), the encoded data in the embedding space wherein classifying comprises determining the hyperplane in the embedding space separating the first class of the encoded data from the second class of the encoded data.
